(19) United States
(12) Patent Application Publication
(10) Pub. No.: US 2009/0040184 A9
(43) Pub. Date: Feb. 12, 2009

(54) Information entry mechanism

(75) Inventors: Kent Qing Pu, San Diego, CA (US); Pavel Stankoulov, San Diego, CA (US); Ivan Angelov, San Diego, CA (US)

Correspondence Address: SILICON VALLEY PATENT AGENCY, 7394 WILDFLOWER WAY, CUPERTINO, CA, 95014, US

(73) Assignee: InfoGation Corporation, San Diego, CA (US)

(21) Appl. No.: 10/924,172

(22) Filed: Aug. 21, 2004

Related U.S. Application Data
(63) Continuation-in-part of application No. 09/971,905, filed on Oct. 4, 2001, now Pat. No. 7,152,213.
(60) Provisional application No. 60/575,930, filed on Jun. 1, 2004.

(51) Int. Cl. G09G 5/00

(52) U.S. Cl. 345/171

(57) ABSTRACT

Techniques for efficiently entering data with a progressively reduced key set are disclosed. According to one aspect of the techniques, an emulated key set is used for entering data within some criteria or confined measures. A key set is generated dynamically each time in accordance with preceding entries. An example of one of the confined measure is a geographic area. Only a set of keys corresponding entries of which are likely to follow the already received entries is provided. Because each time the key set presents fewer and fewer choices, it is therefore easier and more efficient for a user to select and enter data.

### BACKGROUND OF THE INVENTION

1. Field of the Invention

The invention is generally related to the area of information entry mechanism. In particular, the invention is related to solutions for efficiently entering information data on a device with progressively reduced number of keys, wherein the information data may be represented in a language that is entered using alphanumeric characters.

2. The Background of Related Art

There has been a notable increase in the use of the microprocessors for business and cause use. Intelligent electronic devices are becoming much more prevalent in homes, businesses and even in transportation vehicles such as automobiles, boats and airplanes. Such intelligent devices include GPS based navigation systems, personal digital assistants (PDAs), automobile computers, major home appliances, portable computers, telephones, cellular telephones, pagers and the like. Many of these devices require user to input textual data. However, the portable nature of these devices makes the use of traditional keyboards both impracticable and undesirable.

For these reasons, alternative means for inputting textual data have become available. For example, touch screens are used in combination with electronic stylus pen for inputting textual data through handwriting recognition techniques. Many PDAs in use today utilize this method for inputting textual data. However, the accuracy and speed of the handwriting recognition software has been less than satisfactory.

Other devices, such as cellular telephones and the like, utilize standard telephone keypads for inputting alphanumeric data. In one example, a standard telephone keypad attached to a cellular telephone is used not only to dial phone numbers, but to enter names, addresses, and telephone numbers into an electronic address book. The technique commonly used for entering alphanumeric data via a standard telephone keypad is to make use of the alphanumeric information already printed on the keys. This arrangement of information on the keys is used to represent the particular letters that can be entered via each key. For example, the “2” key is used to enter any of the letters printed on the “2” key, namely the letters “A”, “B”, “C” and “2”. The actual letter that is entered into the device depends on the number of times the particular key is successively pressed. For example, pressing the “2” key once results in entering the letter “A”. Pressing the “2” key twice in succession results in entering the letter “B”, and so on. It is evident that this method of entering data is slow and cumbersome.

Another common solution is to replace the conventional keyboard is in the form of a shuttle control system. Generally, a shuttle control system is used to scroll through a list of predefined words, phrases and/or alphanumeric characters. When the desired data item appears on the display, or is highlighted by a cursor, the user selects that item by pressing an enter key. For example, a user can scroll through an alphabet in an ascending or descending order, depending on whether the shuttle key is moved to the right or the left position (or the up or the down position). In some arrangements, the shuttle key can function as the enter key in addition to the direction key. However, as can be imagined, entering data through shuttle control systems can be both time-consuming and problematic.

A regular keyboard is desirable. However, a full sized keyboard is impractical for most portable devices. The static emulation of a full keyboard on a portable device requires a user to ponder around the full set of alphanumeric keys for searching desired letters one at the time. This is not only inefficient, but also dangerous if the portable device is a navigation system in a moving automobile.

There is, therefore, a need for solutions in efficiently entering data on a portable device, and further a need for solutions that minimize the necessity of pondering over keys to enter letters.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention pertains to efficiently entering data with a progressively reduced key set are disclosed. According to one aspect of the techniques, an emulated key set is used for entering data within some criteria or confined measures. A key set is generated dynamically each time in accordance with preceding entries. An example of one of the confined measure is a geographic area. Only a set of keys corresponding entries of which are likely to follow the already received entries is provided. Because each time the key set presents fewer and fewer choices, it is therefore easier and more efficient for a user to select and enter data.

According to another aspect of the present invention, an application module determines a likelihood of being chosen to follow the received one or more entries for each of keys in a reduced set. The keys with higher likelihood are placed in a more obvious manner that other keys such that they can be located quickly and selected much conveniently by a user. The more obvious manners may include, but not be limited to, a key placement, a size, a color and/or 3D representation of the keys in a display.

According to yet another aspect of the present invention, when there are more characters, words, or phrases that may follow what has been entered, an ambiguity is found. To clarify the ambiguity, a list of the characters, words, or phrases is presented for manual selection. When a selection is made, the ambiguity is removed and the entry of a desired character, word, or phrase is complete. This feature increases the efficiency of the data entry.

The present invention may be implemented in many forms including software, hardware or a combination of both. According to one embodiment, the present invention is directed to a method for receiving information via a progressively reduced set of alphanumeric keys, the method comprising: receiving at least one letter corresponding to one of the keys that has been activated; determining a set of letters likely to follow the at least one letter within predefined criteria; and displaying a reduced set of keys in a manner such that one of the reduced set of keys is displayed more obviously than others in the reduced set of keys, wherein the one of the reduced set of keys corresponding to a letter that is most likely to follow the received at least one letter in accordance with the criteria.

According to another embodiment, the present invention is directed to a method for receiving information via a progressively reduced set of alphanumeric keys, the method comprising: receiving sequential entries, each of the entries corresponding to one of a set of keys that is progressively reduced over a preceding one of the entries within predefined criteria; displaying the set of keys each time the set of keys is reduced; when a predetermined number of the entries start to produce the characters, words, or phrases in accordance with the predefined criteria, displaying a set of characters, words, or phrases; receiving a selection of the set of characters, words, or phrases; and accepting the selection to complete an entry thereof.

According to another embodiment, the present invention is an apparatus for receiving information via a progressively reduced set of alphanumeric keys, the portable device comprising: a display screen; a screen driver operable to cause the display screen to display a character, a words or a phrase corresponding to one or more entries; a memory for storing instructions for an application module; and a processor coupled to the screen driver, and the memory, the processor executing the instructions to cause the screen driver to drive the display screen to display a set of keys that is progressively reduced over a preceding one of the entries within predefined criteria. When a predetermined number of the entries start to produce more than one characters, words, or phrases in accordance with a set of predefined criteria, the screen driver is caused to drive the display screen is to display the characters, words, or phrases; request a selection of the characters, words, or phrases; and accept the selection to complete an entry thereof.

One of the objects, features, and advantages of the present invention is to enter information data with minimal searching of the subsequent alphanumeric key set. As a result of this feature, the user is offered a progressive reduced set of keys to locate and input a desired entry. Also the user has less chance to be distracted when searching for a key to input an entry when the most likely choices are placed in more obvious locations than the less likely ones.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 shows an exemplary touch screen display of a key map containing a set of common alphanumeric characters;

FIG. 2 illustrates an exemplary internal functional block diagram of a device in accordance with one embodiment of the present invention;

FIGS. 3A-3E show a sequence of exemplary touch screen displays for entering alphanumeric characters of a city in accordance with one embodiment of the present invention;

FIG. 4A shows another embodiment of FIG. 3A as a color coded touch screen key map display;

FIG. 4B shows another embodiment of FIG. 3C as a color coded touch screen key map display; and

FIG. 4C shows another embodiment of FIG. 4A as a simulated 3D representation of the touch screen key map display with different depths;

FIG. 5 shows a flowchart of process of entering alphanumeric character data information in accordance with one embodiment of the present invention.

### DETAILED DESCRIPTION OF THE PREFERRED EMBODIMENT

The present invention pertains to efficiently entering data via a progressively reduced set of keys in a portable device. According to one aspect of the techniques, a set of keys is used for entering data within confined measures or predefined criteria. In one embodiment, the keys are generated dynamically each time a preceding entry is provided. An example of the predefined criteria is a particular geographic area in which only certain entries can be valid. As entries are progressively provided, the number of keys is progressively reduced. The reduced key sets present fewer and fewer choices, it is therefore easier and more efficient for a user to enter data or activate one of the keys.

According to another aspect of the invention, the likelihood of each of possible entries that may follow the already received entry or entries is determined. A corresponding set of keys is then determined. The key with a highest likelihood is presented in a more obvious manner than the remaining keys in the set. Depending on implementation, the more obvious manner may include, but not be limited to, a placement of the key, a size, a color and/or 3D representation of the key.

According to another aspect of the invention, the position, size, color and/or 3D representation of each key is determined by respective probability of the key to be selected. The probability is used to determine the effect of attracting user's attention to the more likely keys than other remaining keys in a set. To simplify a visual representation of a key set, the visual attributes for each key in a set can be determined from a predefined table indexed by probability levels. In the table, each of the probability level could pertain to associated key size, color, 3D representation or other visual attributes.

According to another aspect of the invention, when the received entries produce results less than a predefined number, the result list is presented to the user for final selection. This allows completing the entry much faster.

According to another aspect of the invention, when the received entries produce only one result, the remaining of the entry is automatically completed without the need for receiving the remaining entries key by key.

According to yet another aspect of the invention, when a predetermined number of received entries start to produce more than one characters, words or phrases within a set of criteria that may cause ambiguities, a list of the characters, words or phrases are displayed such that a user can make a selection that not only clarifies the ambiguities but also complete the entry of a desired character, word or phrase.

The detailed description of the present invention is presented largely in terms of procedures, steps, logic blocks, processing, or other symbolic representations that directly or indirectly resemble the operations of data processing devices. These descriptions and representations are typically used by those skilled in the art to most effectively convey the substance of their work to others skilled in the art. Numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

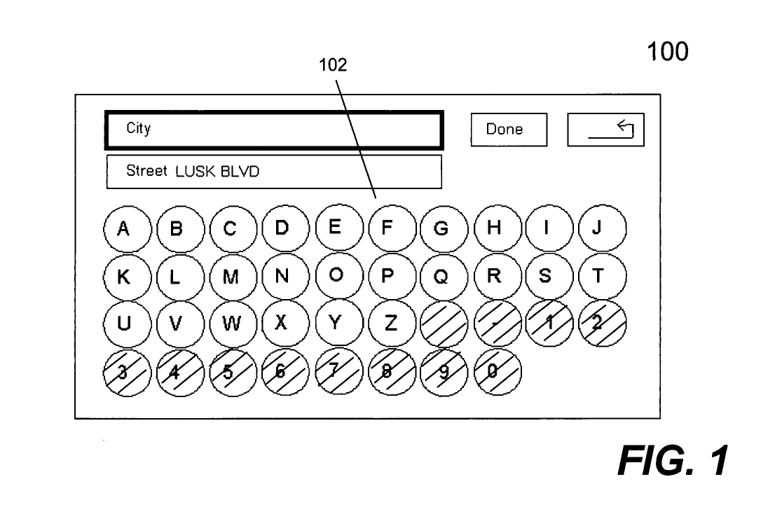

Referring now to the drawings, in which like numerals refer to like parts throughout the several views. FIG. 1 shows an exemplary display 100 of a touch screen in a computing device such as a navigation system, PDA or the like. As used herein, a display screen or a screen is a physical display apparatus in a device, such as a CRT or LCD monitor commonly seen with a computing device. A screen display, a displayed window or simply a display is an image presented on the display screen. In the display 100, there is a region or window 102 showing a key map image, which includes a common set of alphabetic and numeric letters. The touch screen may be part of a computing device, such as a navigation system or PDA, which does not have a full size physical keyboard as commonly attached to the traditional personal computer or workstation. The touch screen facilities means for a user to interact with the device. Traditionally, data or information is entered via the generated key map 102 or soft keys as shown in FIG. 1.

It is evident that the sequential or ascending alphabetical order arrangement of the alphanumeric keys in the key map 102 is different from that of a traditional keyboard. A typical typist can type very fast with keys on the traditional keyboard with two hands only because he or she has been trained to get used to such arrangement. When a computer generated key map is displayed on a relatively small touch screen, there is no obvious advantage to rely on the traditional key arrangement. In many instances, the touch screen is mounted in a vertical orientation, which would be awkward to use the traditional touch typing method to enter information. In general, the user just enters the information with one or two fingers by touching the intended key on the display screen one after another.

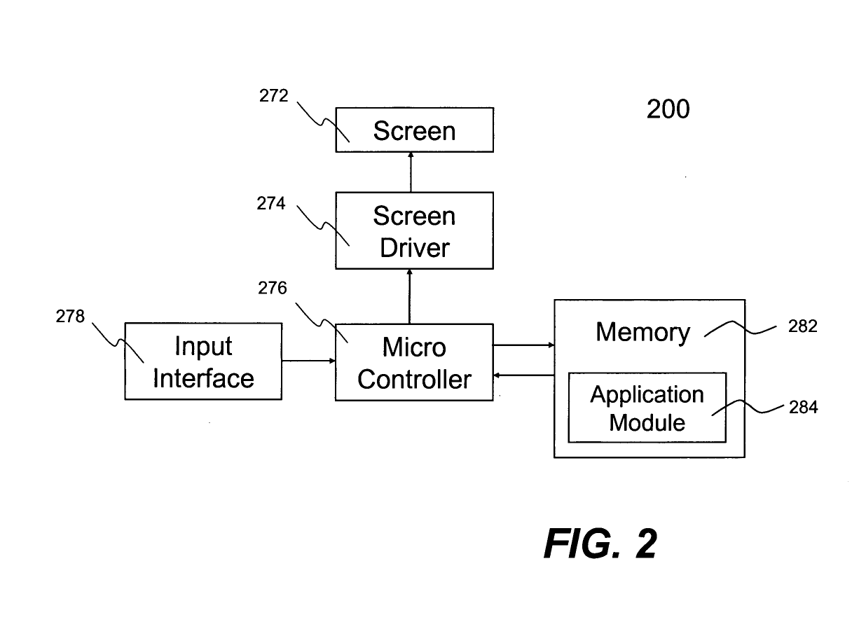

FIG. 2 illustrates an internal functional block diagram 200 of a portable device, such as a cellular phone, a navigation system device or a PDA. The screen 272 may be a LCD touch screen. The screen 272 communicates with and is commanded by a screen driver 274 that is controlled by a microcontroller (e.g., a processor) 276. The memory 282 may be loaded with one or more application modules 284 that can be executed by the microcontroller 276 with or without a user input via the user interface 278 to achieve desired tasks. In one embodiment, an application module is configured to determine a set of valid keys to be displayed, which means that the number of keys is far less than that of the full key map shown in FIG. 1. In another embodiment, an application module is configured to determine a list of keys in an order of likelihoods of corresponding entries that may follow the preceding entries. In operation, when the microcontroller 276 executes one of the application modules 284, the screen driver 274 generates control signals to drive screen 272 to display an application specific user interface accordingly, more of which will be described below.

According to one implementation, an application module 284 is loaded in memory 282 for determining a set of keys to be displayed in accordance with one of confined measures (e.g., a particular geographic area). For example, when a geographic area is defined with a “state” name and a “city” name, the application module 284 is configured to produce a reduced set of keys that is displayed on the screen 272. The user is given an option to locate quickly and activate one or more keys among the reduce set of keys. If it is determined by the application module 284 that the received entries warrant another reduced set of keys, the keys are determined and then displayed. Progressively, the user has fewer and fewer keys to activate, resulting in a speedy entry of characters, words and phrases on a portable device. In one embodiment, the key corresponding to an entry with the highest likelihood is displayed differently from the rest of the keys so that the user can quickly reach and activate the key if it is indeed intended.

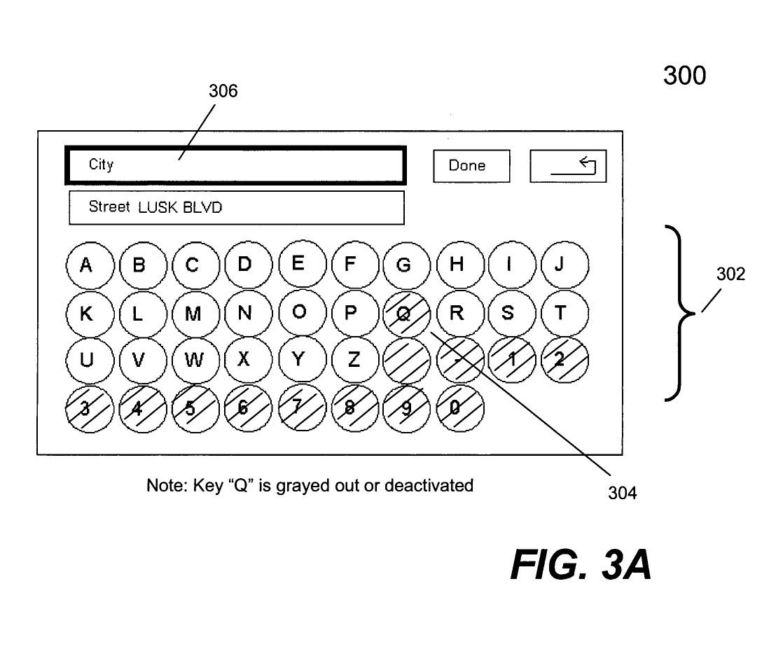

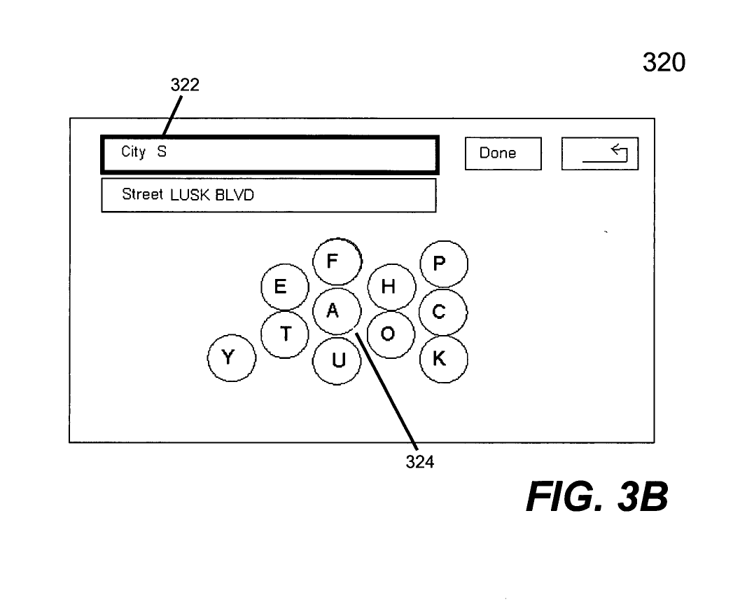

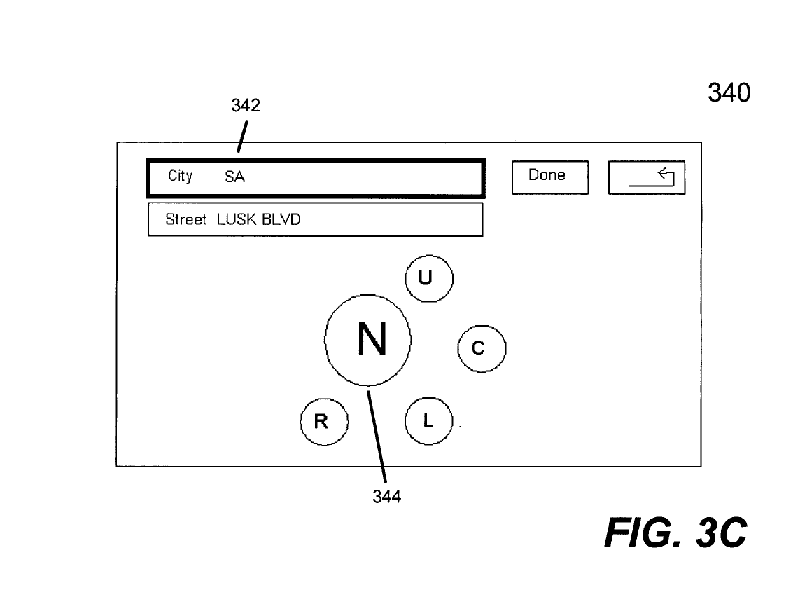

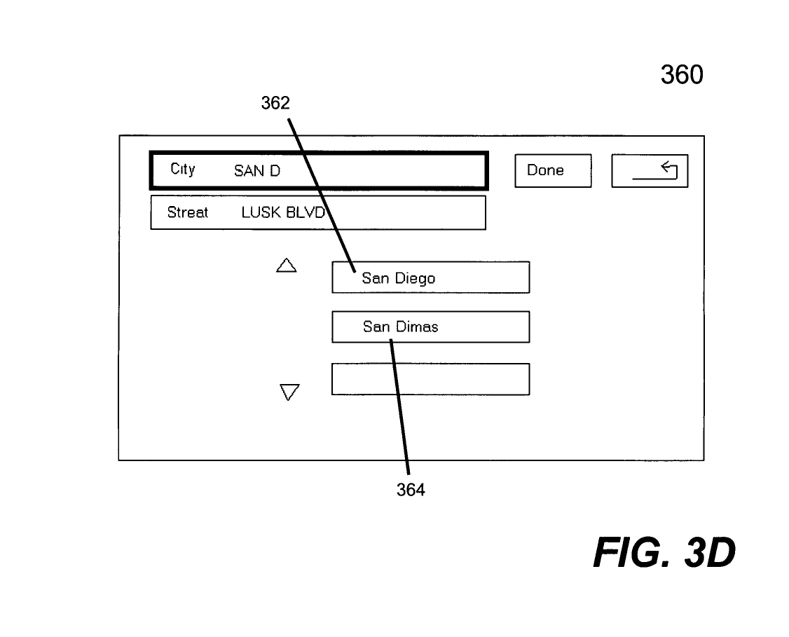

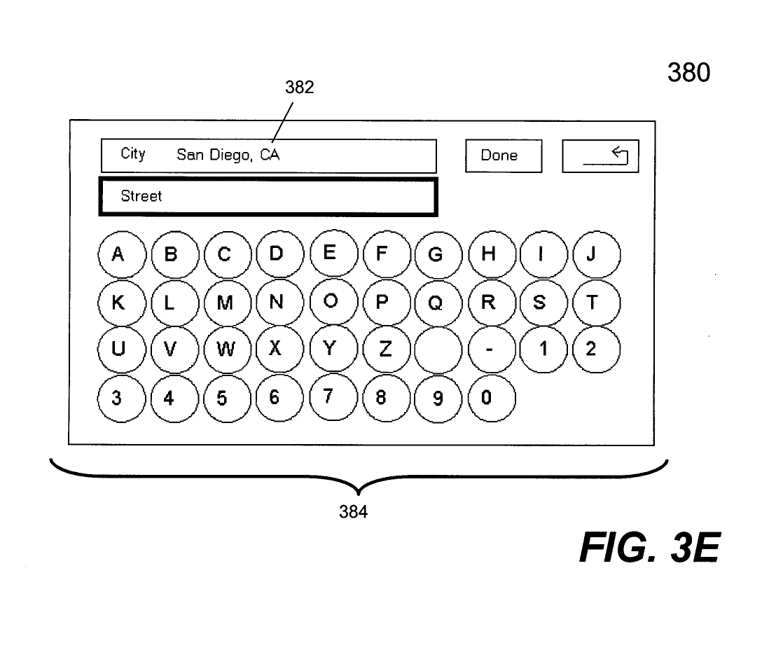

FIGS. 3A-3E show a sequence of displays on a touch screen for entering an address for a driving direction on a portable device to demonstrate one embodiment of the present invention. In FIG. 3A, the display 300 shows a first set of keys 302 for a user to enter “city” information, where a city field 306 is to show the corresponding entries that the user has entered. The display 300 is shown overlapping a road map. Depending upon an exact implementation, the display 300 may be located on any portion of a screen (e.g., a touch screen or a LCD screen with soft keys/buttons) in another embodiment.

Depending on a language in use, the city field 306 may show exactly what is keyed in or a corresponding entry corresponding to a key. For example, in English, when one of the keys 302 “S” is activated, the city field 306 shows an “S”. However, in some oriental languages such as Chinese, one or more characters corresponding to “S” may be shown.

To facilitate the description of the present invention, it is defined herein that an entry is received in accordance with an activated key. Depending on the language in use, the entry may be the activated key or correspond to the activated key. In other words, the city field 306 can be configured to show a letter represented by a key or a non-English character. Unless specifically stated, the following description is based on English.

As shown in FIG. 3A, the display 300 is a first screen display when a user desires to find a direction in an area, for example, of southern California from the user's current location. One of the confined measures or criteria is the area of interest, namely “southern California”. As there is no city or town with a name started with letter “Q” in the area of interest, the key set in the display 300 excludes the key 304 for the letter “Q” such that a user would have fewer choices. According to one embodiment, the key “Q” is grayed out. According to another embodiment, the key “Q” is not shown.

In one embodiment as shown in FIG. 3A, the letters in the key set 302 are in alphabetical order and the numerical numbers are in an ascending order. In another embodiment, the order of the letters and numbers may be in a reverse order or any other combinations of the orders. In yet another embodiment, the order of the letters and numbers in the key set 302 may even be in an order in accordance with a preference.

As soon as the user activates a key “S”, it is determined (e.g., the application module 284 of FIG. 2) that the next set of keys to follow the entry or letter “S” is “A”, “C”, “E”, “H”, “I”, “K”, “0”, “P”, “T”, “U” and “Y” in southern California (i.e., one of the confined measures). Therefore only eleven keys for letters “A”, “C”, “E”, “H”, “I”, “K”, “0”, “P”, “T”, “U” and “Y” are displayed 320 as shown in FIG. 3B. Also shown in FIG. 3B, an “S” 322 is displayed in the city field of the display 320 to reflect that the user has inputted one data entry.

With a fewer number of keys, the display of these keys can be configured to fit more conveniently in a display screen or utilize soft keys. In one embodiment, the key for letter “A” 324 is placed in the middle of the key set for easiest access and selection. The reason is that the letter “A” 324 has the highest likelihood to follow letter “S” based upon a determination from the application module. Similarly for other probable letters, the keys for letters “E”, “I”, “H”, “0”, “U” and “T” are placed right next to the key for “S”, because those letters have the next highest likelihood to follow letter “S” in the southern California area. One of the features in the present invention is that the most probable letters are intelligently arranged so that the user can easily locate and choose a desired key.

FIG. 3C shows an exemplary screen display 340 with five keys, a further reduced key set. The screen display 340 is a result of the user having entered the letter “A” following the letter “S” in the city field of the display 340. After the preceding entries “SA”, the application module 284 of FIG. 2 is configured to determine a further reduced set of keys that may likely to follow the preceding entries “SA”. As shown in FIG. 3C, the reduced set of keys includes five keys: “C”, “L”, “N”, “R” and “U”. Given the geographic area, the letter “N” is determined to have the highest likelihood to follow “SA”. According to one embodiment, the key for “N” is not only placed in the middle of the display, it is also shown as an enlarged key “N” 344. The intelligent placement and display of the key “N” facilitates means for a user to quickly locate and select the next key to enter an entry.

After the user entered the letter “N” by activating the key for the letter “N”, “ ” and “D” the resulting screen display 360 is shown in FIG. 3D. Instead of showing a key map for user to provide a next entry, a screen display of two cities: San Diego 362 and San Dimas 364, is shown. The reason to give user an option to choose one of the cities listed is that there are two cities in the region of the interest (e.g., southern California) having the name starting with “SAN D”, which causes an ambiguity and needs to be clarified. The application module does not require user to continue entering letters one by one. Instead, the choices are presented to the user to select in order to clarify the ambiguity and to finish the entry.

If there is no ambiguity, the application module will automatically complete the entry. One of the important features in FIG. 3C is that a user may not need to move around to activate a key on a display. As keys corresponding to respective entries with a highest likelihood to follow one or more preceding entries are shown one after another on substantially similar position on a display, all the user needs to do is to repeatedly activate on the position to enter the entries.

FIG. 3E shows an updated screen display 380 after the user has selected “San Diego” in the previous screen display 360 of FIG. 3D or completed the entry of the city name. The selected city “San Diego” is listed in the city field 382. A key map 384 includes keys for all of the alphanumeric letters is shown again for the user to enter other information, such as the street name that could also include numerals (for example “1^{st} street”).

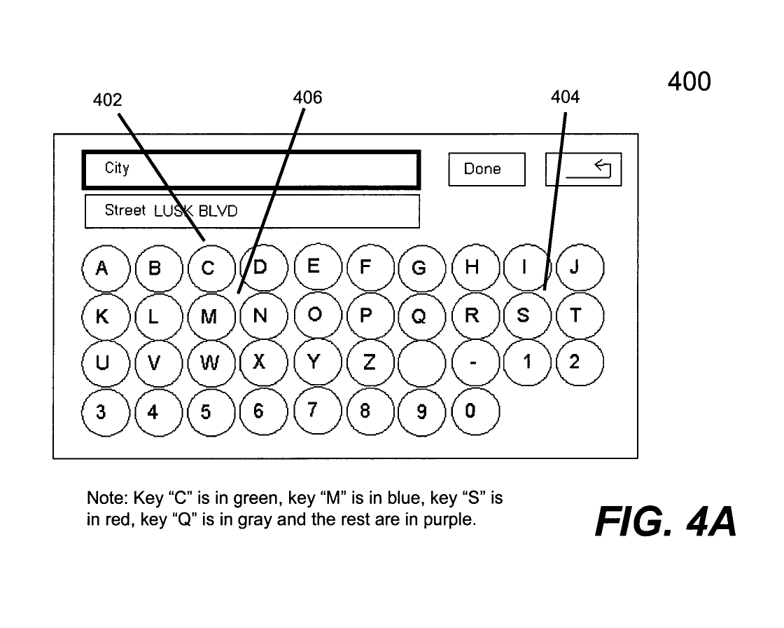

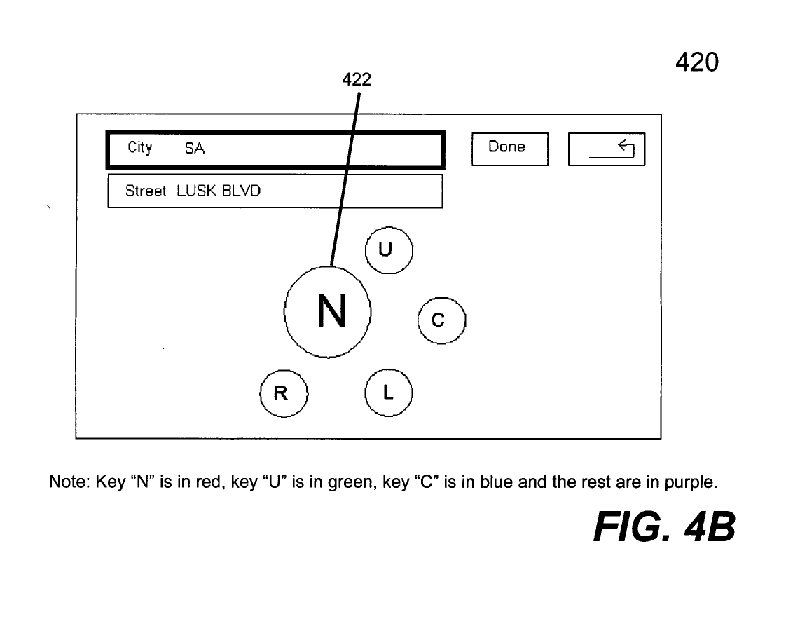

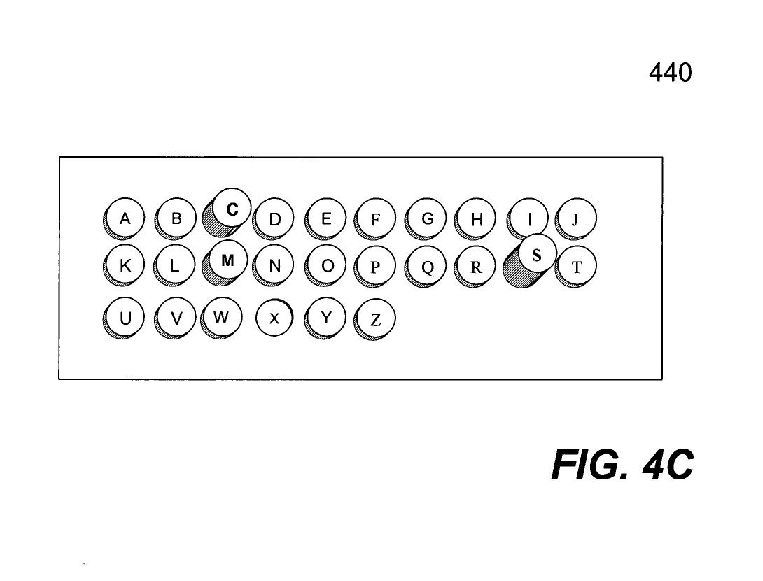

FIG. 4A shows another embodiment of FIG. 3A. In stead of showing a reduced set of keys (ruling out a key “Q”), the screen display 400 shows three keys “C” 402, “S” 404 and “M” 406 that are highlighted. In one embodiment, these selected keys in display 400 are highlighted with different colors from the rest of keys. Each of the three highlighted color keys is determined based on a lookup history, popularity, a frequency and other determinations pertaining to a use of the device. For example, a real estate agent often needs to look for a selected number of cities within a local area. Whenever, his/her portable a navigation system is turned on, the first letter of the city names in the local area could be highlighted so that it would make the selection process much easier.

According to one embodiment, one of the highlighting methods is to use one or more different colors to highlight these keys. The order of the colors keys may be determined by a personal choice that may be asked for input when the device is initiated or by a common alerting order. According to another embodiment, one of the highlighting methods is to flash one or more of these keys to get immediate attention from the user.

Another one of the highlighting method is to show the keys that are more likely to follow the preceding entries with a 3D visual representation that makes them stand out compared to the other keys. One possible way to achieve this to increase the shadow or the depth of the keys that are likely to follow the preceding entries. FIG. 4C illustrates one implementation. The changed 3D appearance attracts the user's attention to the most likely keys and thus makes the input faster.

Returning now to FIG. 3C, another highlighting method is to show and enlarge a key corresponding to an entry that is most likely to follow the preceding entries. Given the preceding entries “SA”, the key for “N” 344 is shown as a much larger key comparing to all other keys. FIG. 4B shows another embodiment of FIG. 3C. In the screen display 420, the key for “N” 422 is displayed not only larger than other keys but also in a different color. It should be understood to those skilled in the art that the letter that is most likely to follow what has been entered may be determined in many ways, such as probability of a name being searched, a user's old history, popularity, frequency and other determinations.

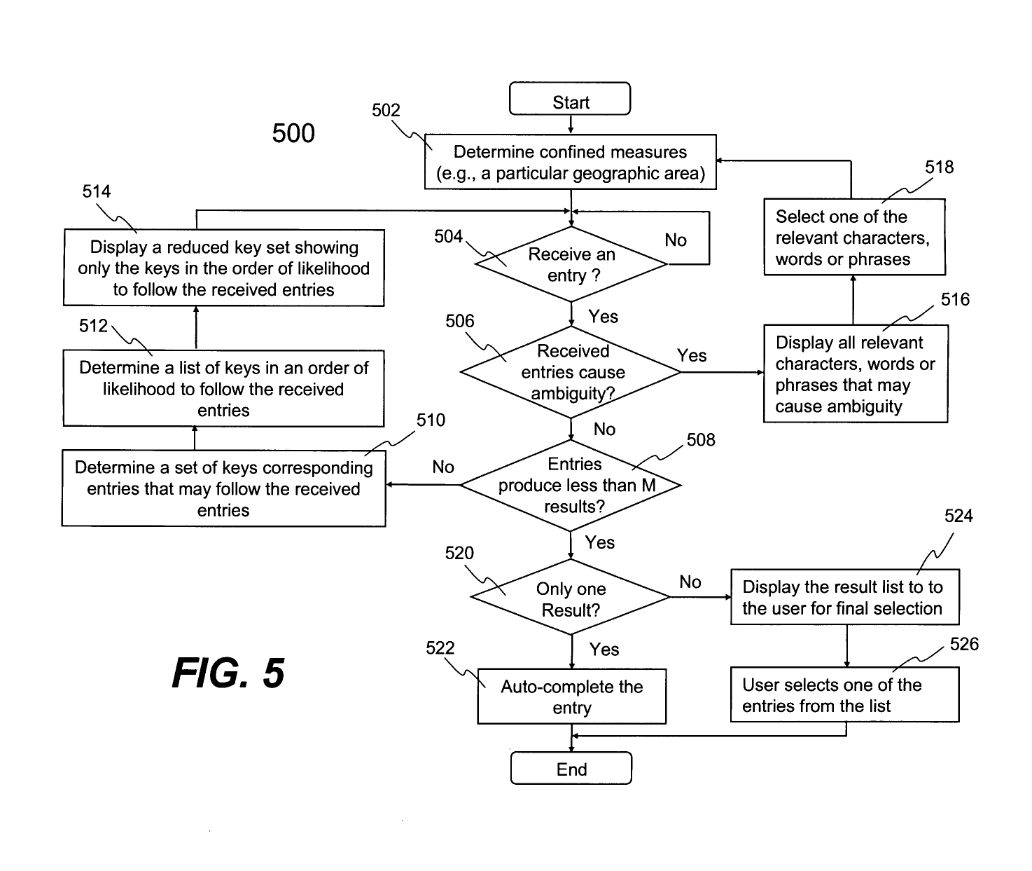

Referring now to FIG. 5, there is shown a flowchart or process 500 of displaying a reduced key set for user entering data in accordance with one embodiment of the present invention. The process 500, which is preferably understood in conjunction with the previous figures, especially with FIGS. 3A-E and 4A-B, may be implemented in software, hardware, or a combination of both. According to one embodiment, an application module implementing the process 500 is embedded in a computing device, for example, a navigation device. The application module 284 may be loaded in the memory 282 to be executed by the microcontroller (processor) 276 and operating in conjunction with user input commands via a touch screen input interface 278 or a screen with a key pad operable with soft keys displayed in a screen.

The process 500 starts with a display of a key set at 502 based on some criteria or confined measures such as a selected geographic area. In general, an emulated key set presented to the user at 502 includes keys that are possible in the confined measures. For example, the screen display 300 of FIG. 3A is displayed for a user to enter a city in southern California. The key set 302 includes all letters but “Q”, because there is no name of a city started with “Q” in this geographic area. Then the process 500 waits until an entry has been entered at 504 via the emulated key set. Once a key is activated and an entry is received, the process 500 performs a test at 506 to test whether there is any ambiguity caused by the received data. In general, a single entry could cause a lot of ambiguities as there are more characters, words, or phrases to follow a single entry. According to one embodiment, the test at 506 only occurs when there are a predefined number of entries, for example, three entries. Depending on the result of the test, the process 500 splits into two branches.

If there is no ambiguity at 506, the process 500 moves to check condition 508, which determines whether received entries can generate results that are less than a predefined number M. M is a small number (e.g. 4, 6 or 8) that allows the user to select quickly the desired text entry. According to one embodiment M could be a possible number of entries that can fit in one screen and thus allow for quick user selection.

If the results are more than the predefined number M at 508, the process 500 moves to 510, the process 500 determines another set of keys that may follow the preceding entries received so far. In the example of FIG. 3B, there is a set of 11 keys after the user has entered “S” for a city name in the southern California. In additional to determining the set of keys, the process 500 ranks each of the keys in the set based on the likelihoods of entries corresponding to the keys to follow the received entries at 512. At 514, the process 500 displays another set of keys includes a further reduced number of keys (e.g., FIGS. 3B and 3C). In one embodiment, the keys are linearly arranged according to the corresponding likelihood thereof. In another embodiment, the key with the highest likelihood is placed in a center position of the displayed key set. The remaining keys are placed around the highest likelihood key in order of decreasing likelihood such that keys close to the center position have an equal or higher likelihood than those further away from the center position (e.g., FIG. 3B). In another embodiment, the higher likelihood keys may be displayed with a larger key than the remaining lower likelihood keys (e.g., FIG. 3C). The higher likelihood keys may also be displayed with a larger key and/or in different colors (e.g., FIG. 4B). In yet another embodiment, where all the keys are simulated with a 3D representation, the higher likelihood keys may be displayed with different depths (e.g., FIG. 4C). At this point, the process 500 moves back to 504 for the next user input repeating the whole process until the results become less than M at 508.

When an ambiguity has been created with the received data or entries at 506, the process 500 moves to 516. Instead of generating another key set, the process 500 displays all the possible or relevant characters, words or phrases that could associated with what has been entered (e.g., FIG. 3D). This is important for a data entry in a non-western language such as Chinese, Japanese, and Korean. After presenting all of the possibilities, at 518, the user selects one of the choices to clarify the ambiguity, which may complete the entry of a desired character, word or phrase. The process 500 moves back to 502 to start it all over for another entry of a character, a word or a phrase.

When the entries produce results with number less than the predefined threshold M at 508, the process 500 checks if the previous entries can lead to only one result at 520. If there is only one possible result, it is automatically completed at 522 and the process ends after that. If the results are more than one (but less than M, as checked by condition 508) they are presented to the user in a form of list at 524 (e.g. FIG. 3D), from which he or she can make the final selection. After the final selection at 526, the process 500 ends.

The present invention can be implemented in many ways, each of them may yield one or more of the following benefits, advantages or features. One of the key features, benefits and advantages in the present invention is to facilitate efficient entry of information with a progressively reduced set of keys so that a user can quickly locate and activate a desired key to input an entry. Other benefits, advantages or features can be appreciated by those skilled in the art given the detailed description provided herein.

While the present invention has been described with reference to specific embodiments, the description is illustrative of the invention and is not to be construed as limiting the invention. Various modifications to the present invention can be made to the preferred embodiments by those skilled in the art without departing from the true spirit and scope of the invention as defined by the appended claim. For example, the present invention can be implemented in any computing system requiring user entering information via a touch screen or a LCD screen with soft keys/buttons. In one case, a remote controller may be used to activate one of the keys being displayed. If a highlighted key in each of progressively reduced key sets is the one to be activated for an entry or part of an entry, a repeated activation on a button in the remote controller can speedily complete an entry. Accordingly, the scope of the present invention is defined by the appended claims rather than the forgoing description of embodiments.

We claim:

1. A method for receiving information via a progressively reduced set of alphanumeric keys, the method comprising:
receiving at least one letter corresponding to one of the keys that has been activated;
determining a set of letters likely to follow the at least one letter within predefined criteria; and
displaying a reduced set of keys in a manner such that one of the reduced set of keys is displayed more obviously than others in the reduced set of keys, wherein the one of the reduced set of keys corresponding to a letter that is most likely to follow the received at least one letter in accordance with the criteria.

2. The method of claim 1, further comprising displaying a further reduced set of keys in a manner such that one of the further reduced set of keys is displayed more obviously than others in the further reduced set of keys, wherein the one of the further reduced set of keys corresponding to a letter that is most likely to follow the at least one letter and what is selected from the reduced set of keys with the criteria.

3. The method of claim 1, wherein the at least one letter begins a formation of a character, a word or a phrase in a language.

4. The method of claim 2, wherein the language includes Chinese, Japanese, and Korean.

5. The method of claim 1, wherein one of the criteria pertains to a particular geographic area.

6. The method of claim 4, when the received at least one letter causes ambiguity in one of the criteria, the method further includes:
displaying all relevant characters, words or phrases that are begun with the received at least one letter;
receiving a selection of the relevant characters, words or phrases; and
displaying the selection.

7. The method of claim 6, wherein each of the relevant characters, words or phrases includes a name of cities or streets.

8. The method of claim 1, the method further includes:
determining likelihoods of respective letters corresponding to the reduced set of keys; and
determining an order of the likelihoods.

9. The method of claim 8, wherein the displaying of the reduced set of keys includes arranging linearly the keys in the reduced set according to the order.

10. The method of claim 8, wherein one of the keys in the reduced set is displayed in a different size or color than other keys in the reduced set, wherein the one of the keys corresponds to a letter that has a higher likelihood than that of other keys in the reduced set.

11. The method of claim 1, wherein the displaying of the reduced set of keys includes positioning one of the keys in the reduced set in a center position and others in the valid letters in surrounding positions, wherein the one of the keys corresponds to a letter that has a higher likelihood than that of other keys in the reduced set.

12. The method of claim 11, wherein one or more keys that have higher probabilities are displayed larger than the remaining keys in the reduced set.

13. The method of claim 12, wherein the keys in the reduced set are respectively represented in variable sizes in accordance with their respective probabilities such that as one of the probabilities increases a size of a corresponding key increases as well.

14. The method of claim 11, wherein one or more keys that have higher probability than the other keys are displayed in a first color or user defined color, and remaining keys are displayed in a second color.

15. The method of claim 14, wherein the first color and the second color are predefined by user.

16. The method of claim 1, wherein the reduced set of keys is displayed a touch screen of a device, a letter is entered when a corresponding key of the reduced set of keys is activated.

17. The method of claim 1, wherein the one of the reduced set of keys and the one of the further reduced set of keys are sequentially displayed on a substantially identical position of a touch screen such that repeated activations of the position result in entries of at least two letters respectively corresponding to one of the reduced set of keys and the one of the further reduced set of keys.

18. The method of claim 1, wherein the one of the reduced set of keys and the one of the further reduced set of keys are sequentially displayed in a highlighting manner such that repeated activations of a button result in speedy entry of at least two letters respectively corresponding to one of the reduced set of keys and the one of the further reduced set of keys.

19. A method for receiving information via a progressively reduced set of alphanumeric keys, the method comprising:
receiving sequential entries, each of the entries corresponding to one of a set of keys that is progressively reduced over a preceding one of the entries within predefined criteria;
displaying the set of keys each time the set of keys is reduced;
when a predetermined number of the entries start to produce the characters, words, or phrases in accordance with the predefined criteria,
displaying a set of characters, words, or phrases;
receiving a selection of the set of characters, words, or phrases; and
accepting the selection to complete an entry thereof.

20. The method of claim 19, wherein the displaying of the set of keys comprises:
determining a likelihood of an entry corresponding to one of the keys to follow the preceding one of the entries; and
displaying one of the keys in a manner that the one of the keys is most conveniently accessible, wherein the one of the keys corresponding to an entry with a likelihood that is higher than that of other entries.

21. The method of claim 20, wherein the manner is to have the one of the keys displayed in a substantially central position of a touch screen such that the sequential entries are received when the position of the touch screen is repeated activated with the set of keys that is progressively reduced over a preceding one of the entries within predefined criteria.

22. The method of claim 20, wherein the manner is to have the one of the keys displayed in a color that catches immediate attentions from a user.

23. The method of claim 20, wherein the likelihood pertains to a probability, a frequency and a history and a popularity of the entry.

24. The method of claim 19, wherein the displaying of the set of keys comprises:
determining a likelihood of an entry corresponding to one of the keys to follow the preceding one of the entries; and
displaying one of the keys in a manner that the one of the keys is most conveniently accessible, wherein the one of the keys corresponding to an entry with a likelihood that is higher than that of other entries.

25. The method of claim 19, wherein the manner is to have the one of the keys displayed in a substantially central position of a touch screen such that the sequential entries are received when the position of the touch screen is repeated activated with the set of keys that is progressively reduced over a preceding one of the entries within predefined criteria.

26. The method of claim 25, wherein the manner is to have the one of the keys displayed in a color that catches immediate attentions from a user.

27. The method of claim 25, wherein the likelihood pertains to a probability, a frequency and a history and a popularity of the entry.

28. The method of claim 19, wherein the manner is to have the one of the keys displayed in a substantially central position of a screen of a device such that the sequential entries are received when repeated activation of a single button on a remote controller of the device, and wherein the one of the keys is one of progressively reduced key sets.

29. A portable device for receiving information via a progressively reduced set of alphanumeric keys, the portable device comprising:
a display screen;
a screen driver operable to cause the display screen to display a character, a words or a phrase corresponding to one or more entries;
a memory for storing instructions for an application module; and
a processor coupled to the screen driver, and the memory, the processor executing the instructions to cause the screen driver to drive the display screen to
display a set of keys that is progressively reduced over a preceding one of the entries within predefined criteria;
when a predetermined number of the entries start to produce more than one characters, words, or phrases in accordance with a set of predefined criteria,
display the characters, words, or phrases;
request a selection of the characters, words, or phrases; and
accept the selection to complete an entry thereof.

30. The portable device of claim 29, wherein the display screen is a touch screen, and wherein, every time the set of keys is displayed, one of the keys is shown in a substantially central position of the touch screen, an entry corresponding to the one of the keys is most likely to follow one or more preceding entries thereof.

31. The portable device of claim 30, wherein repeated activations on the position of the touch screen result in acceptance of the entries.

32. The portable device of claim 29, wherein the display screen is a touch screen, and wherein, ever time the set of keys is displayed, one of the keys is shown in a color and/or a size that requires immediate attentions from a user, an entry corresponding to the one of the keys is most likely to follow one or more preceding entries thereof.

33. The portable device of claim 32, wherein, when one of the keys is shown in the color and/or the size, other remaining keys in the set of keys are displayed differently.

34. The portable device of claim 29 further including a remote controller, portable device, and wherein repeated activation of a button on the remote controller results in an entry of the one of the keys in the progressively reduced key set.
